(19) United States
(12) Patent Application Publication
(10) Pub. No.: US 2013/0271584 A1
(43) Pub. Date: Oct. 17, 2013

(54) USER WEARABLE VISUAL ASSISTANCE DEVICE

(71) Applicant: Orcam Technologies Ltd., Jerusalem (IL)

(72) Inventors: Yonatan Wexler, Jerusalem (IL); Amnon Shashua, Jerusalem (IL); Oren Tadmor, Beit Zait (IL); Itai Ehrlich, Mevo Horon (IL)

(21) Appl. No.: 13/914,792

(22) Filed: Jun. 11, 2013

Related U.S. Application Data
(63) Continuation-in-part of application No. 13/397,919, filed on Feb. 16, 2012.
(60) Provisional application No. 61/443,776, filed on Feb. 17, 2011.
(60) Provisional application No. 61/443,739, filed on Feb. 17, 2011.

(30) Foreign Application Priority Data
Feb. 15, 2013 (EP) EP13275033.2

(51) Int. Cl. G06K 9/00

(52) U.S. Cl. CPC G06K 9/00355
USPC 348/62

(57) ABSTRACT

A device wearable by a person including a processor operatively connectible to a camera. The processor is adapted to capture multiple image frames, is operable to detect motion of a gesture by using differences between the image frames and to classify the gesture responsive to the detected motion.

### CROSS REFERENCE TO RELATED APPLICATIONS

The present application claims priority from European Patent Application No. EP13275033.2, filed on Feb. 15, 2013, and is a continuation-in-part of U.S. patent application Ser. No. 13/397,919, filed on Feb. 16, 2012, which claims priority from U.S. Provisional Patent Application No. 61/443,776 filed on Feb. 17, 2011 and U.S. Provisional Patent Application No. 61/443,739 filed on Feb. 17, 2011, the disclosures of which are hereby incorporated herein by reference.

### BACKGROUND OF THE INVENTION

1. Technical Field

Aspects of the present invention relate to vision processing.

2. Description of Related Art

The visually impaired suffer from difficulties due to lack of visual acuity, field of view, color perception and other forms of visual impairments. These challenges impact life in many aspects for example mobility, risk of injury, independence and situational awareness in everyday life.

Many products offer solutions in the realm of mobility such as global positioning system (GPS), obstacle detection without performing recognition, and screen readers. These products may lack certain crucial aspects to integrate fully and seamlessly into the life of a visually impaired person.

Thus, there is a need for and it would be advantageous to have a device which enhances quality of life for the visually impaired.

### BRIEF SUMMARY OF THE INVENTION

Various methods for visually assisting a person are provided for herein using a device wearable by the person. The device includes a processor connectible to a camera. The processor is adapted to capture multiple image frames. Motion of a gesture is detected by using differences between the image frames. The gesture may be classified (recognized or re-recognized) responsive to the detected motion. The motion of the gesture may be repetitive. The detection and classification of the gesture are performed while avoiding pressing of a button on the device.

The gesture includes holding an object in a hand of the person, enabling the person to audibly name said object; and recording the name. Upon failing to classify the object the person may be audibly informed. The gesture may include waving the object in the field of view of the camera and classifying the object. The classification may be performed using a trained classifier. If the device fails to detect a new object, the classifier may be further trained by the person audibly naming the new object. The motion detection may be performed by identifying portions of a hand holding the object. The motion detection includes detection of features of an image of the object, tracking the features within the image between the image frames and grouping the features into groups. The groups include features with similar image movement. Optical character recognition (OCR) of characters on the object may be performed.

Various devices are provided for herein wearable by the person The device includes a processor operatively connectible to a camera. The processor is adapted to capture multiple image frames, to detect motion of a gesture by using differences between the image frames and to classify the gesture responsive to the detected motion. The motion of the gesture may be repetitive. An earphone may be attached to the processor. The device detects an object and recognizes the object. The processor audibly informs the person by utilizing the earphone to name the object.

### BRIEF DESCRIPTION OF THE DRAWINGS

The invention is herein described, by way of example only, with reference to the accompanying drawings, wherein:

FIG. 1 shows a system diagram, according to aspects of the present invention.

FIG. 2a shows an isometric view of an apparatus, according a feature of the present invention.

FIG. 2b shows an alternative isometric view of the apparatus shown in FIG. 2a, according to a feature of the present invention.

FIG. 3 shows eyeglasses retrofit according to a feature of the present invention.

FIG. 4 shows retrofit of eyeglasses shown in FIG. 3 with a portion of the apparatus shown in FIGS. 2a and 2b, according to a feature of the present invention.

FIG. 5a-5c, FIG. 6 and FIGS. 7-8 are flow diagrams which illustrate processes according to different features of the present invention.

FIG. 9a shows a person wearing eyeglasses retrofit as shown in FIG. 4 and gesturing, according to a feature of the present invention.

FIGS. 9b-9e show other possible hand gestures in the visual field of the camera, according to different aspects of the present invention.

FIGS. 10-14 shows further examples of a person wearing and using the device of FIG. 4 for detecting and recognizing text, a bus, a bank note, a traffic signal and holding an object, according to different aspects of the present invention.

FIGS. 15a, 15b illustrate image frames according to different aspects of the present invention.

FIG. 16a illustrates a process in which a user names an object being held, according to a feature of the present invention.

FIG. 16b illustrates a process in which the device recognizes the object previously held in the process of FIG. 16a, according to a feature of the present invention.

FIG. 17a shows a flowchart of a method of detecting gesture motion, according to a feature of the present invention.

FIG. 17b shows an aspect of the detection step of the method illustrated in FIG. 17a in greater detail.

FIG. 18a shows a flow diagram of a method, according to a feature of the present invention.

FIG. 18b shows a flow diagram of a method which provides greater detail to a step of the method illustrated in FIG. 18a, according to a feature of the present invention.

FIG. 18c shows a flow diagram of a method which provides greater detail to a step of the method illustrated in FIG. 18b, according to a feature of the present invention.

### DETAILED DESCRIPTION

Reference will now be made in detail to features of the present invention, examples of which are illustrated in the accompanying drawings, wherein like reference numerals refer to the like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings. The invention is capable of other features or of being practiced or carried out in various ways. Also, it is to be understood that the phraseology and terminology employed herein is for the purpose of description and should not be regarded as limiting.

By way of introduction, embodiments of the present invention utilize a user-machine interface in which the existence of an object in the environment of a user and a hand gesture trigger the device to notify the user regarding an attribute of the object. The device may be adapted to learn the preferences of the user. In that sense, the device is extensible and gradually suits the user better with use, since the preferences of the user may be learned in time with use of the device.

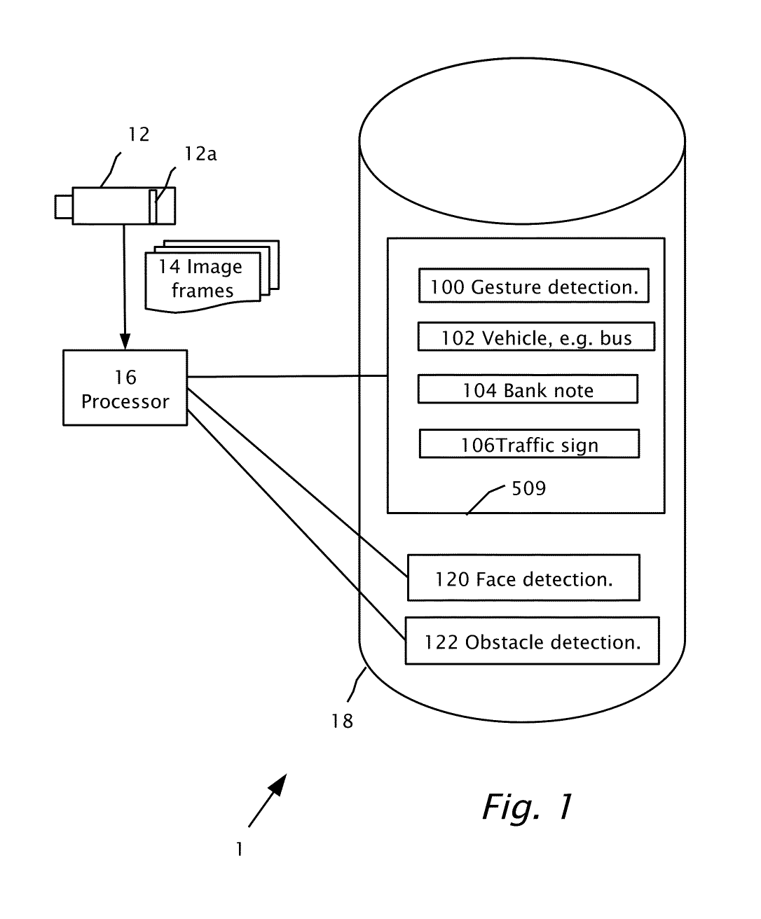

Reference is now made to FIG. 1 which illustrates a system 1, according to a feature of the present invention. A camera 12 with image sensor 12a captures image frames 14 in a forward view of camera 12. Camera 12 may be a monochrome camera, a red green blue (RGB) camera or a near infrared (NIR) camera. Image frames 14 are captured and transferred to processor 16 to be processed. The processing of image frames 14 may be based upon algorithms in memory or storage 18. Storage 18 is shown to include a classifier 509 which may include gesture detection 100, vehicle detection and recognition 102, bank note detection and recognition 104 and/or traffic sign detection and recognition 106. Classifier 509 may be a multi-class classifier and may include, for example, multiple classes of different images of different objects including bank notes, vehicles, e.g. buses, traffic signs and/or signals, and gestures. Another classifier may be available for face detection 120. A method may be available for obstacle detection 122 with or without use of an additional sensor (not shown)

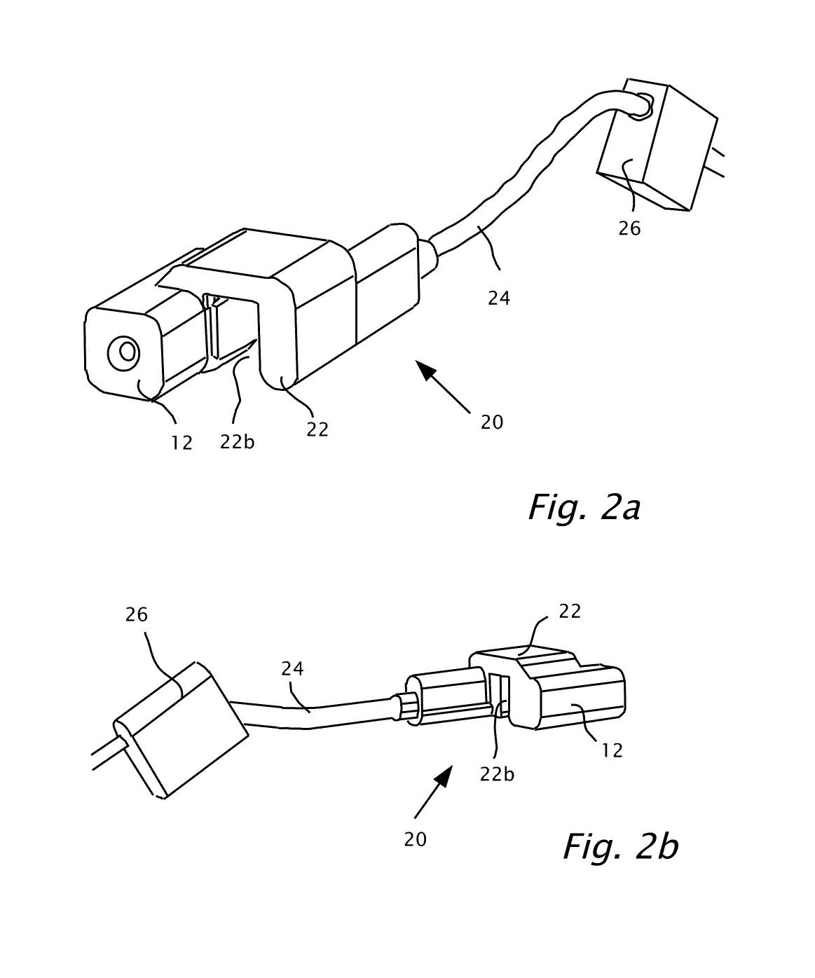

Reference is now made to FIG. 2a which shows a view of an apparatus 20, according a feature of the present invention. Camera 12 may be located in a housing which is attached to a mount 22. Mount 22 connects electrically to an audio unit 26 via a cable 24. A slot 22b is located between camera 12 and mount 22. Both camera 12 and audio unit 26 may be operatively connected to processor 16 and optionally to storage 18. Processor 16 and storage 18 may be a custom unit or alternatively may be part of a mobile computer system, e.g. smart phone. Audio unit 26 (not shown) may be an audio speaker which may be in close proximity to and/or attached the ear of the user or located and attached at the bend in arm 32. Alternatively, audio unit 26 may be a bone conducting headphone set which may conduct through to one ear or to both ears of the person. Unit 26 may also be a earphone connected to processor 16 by a wireless connection, e.g. BlueTooth®™.

Reference is now made to FIG. 2b which shows an alternative view of apparatus 20, showing camera 12, mount 22, slot 22b, cable 24 and audio unit 26, according to a feature of the present invention.

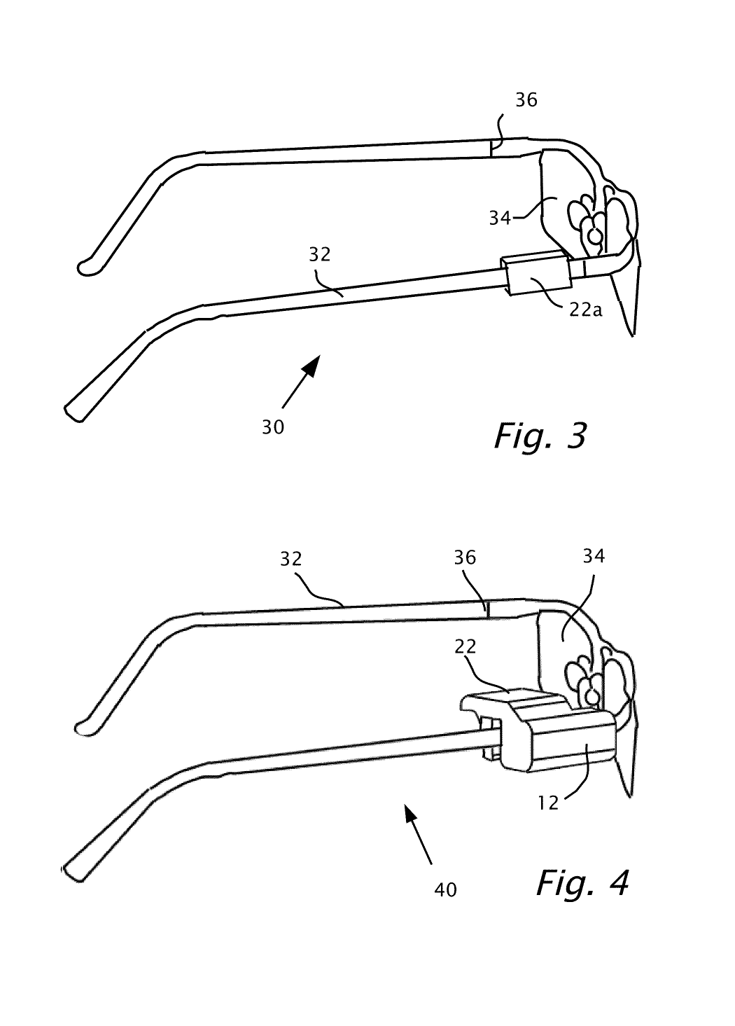

Reference is now made to FIG. 3 which shows eyeglasses 30 retrofit according to a feature of the present invention. Eyeglasses 30 have two arms 32 connected to the frame front of eyeglasses 30 with hinges 36. The frame front holds the lenses 34 of eyeglasses 30. A docking component 22a is attached to an arm 32 near to the frame front but just before hinge 36.

Reference is now made to FIG. 4 which shows a device 40 of eyeglasses retrofit with an apparatus according to a feature of the present invention. Camera 12 may be docked on docking component 22a so that slot 22b between mount 22 and camera 12 slides onto docking component 22a. A magnetic connection between the slot and docking component 22a may allow camera 12 and mount 22 to be attachable, detachable and re-attachable to eyeglasses 30 via docking component 22a. Alternatively, a spring loaded strip located in the slot or on either side of docking component 22a (located behind hinge 36) may be utilized to allow camera 12 to be attachable, detachable and re-attachable to eyeglasses 30. Any other means known in the art of mechanical design may alternatively be utilized to allow camera 12 to be attachable, detachable and re-attachable to eyeglasses 30. Camera 12 is therefore, located to capture images frames 14 with a view which may be substantially the same view (provided through lenses 34 if applicable) of the person wearing eyeglasses 30. Camera 12 is therefore, located to minimize parallax error between the view of the person and view of camera 12.

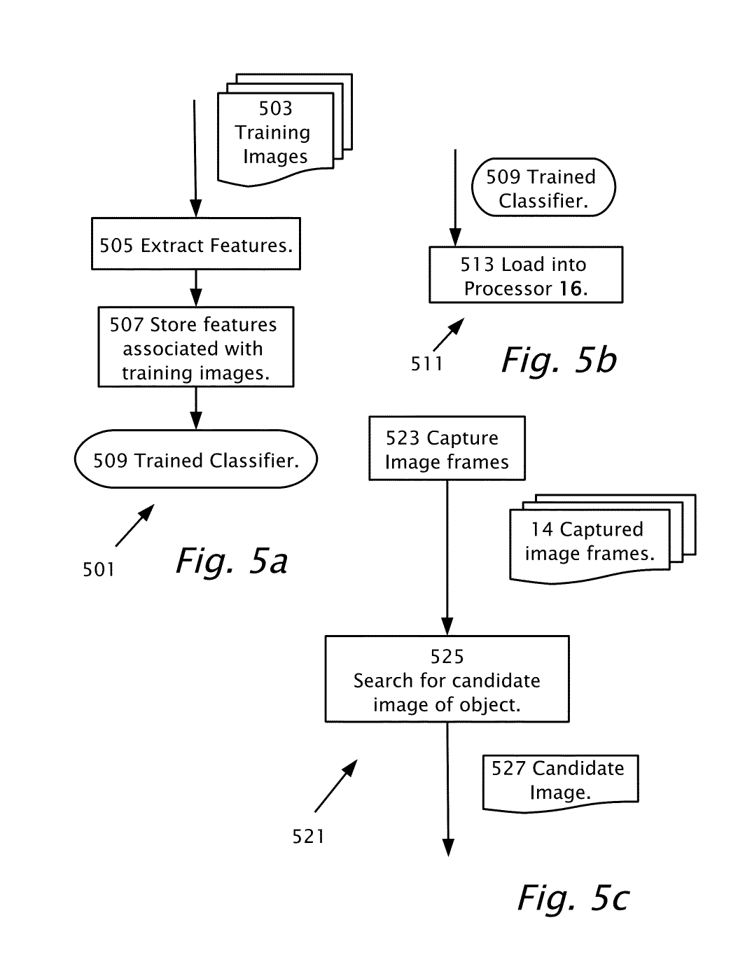

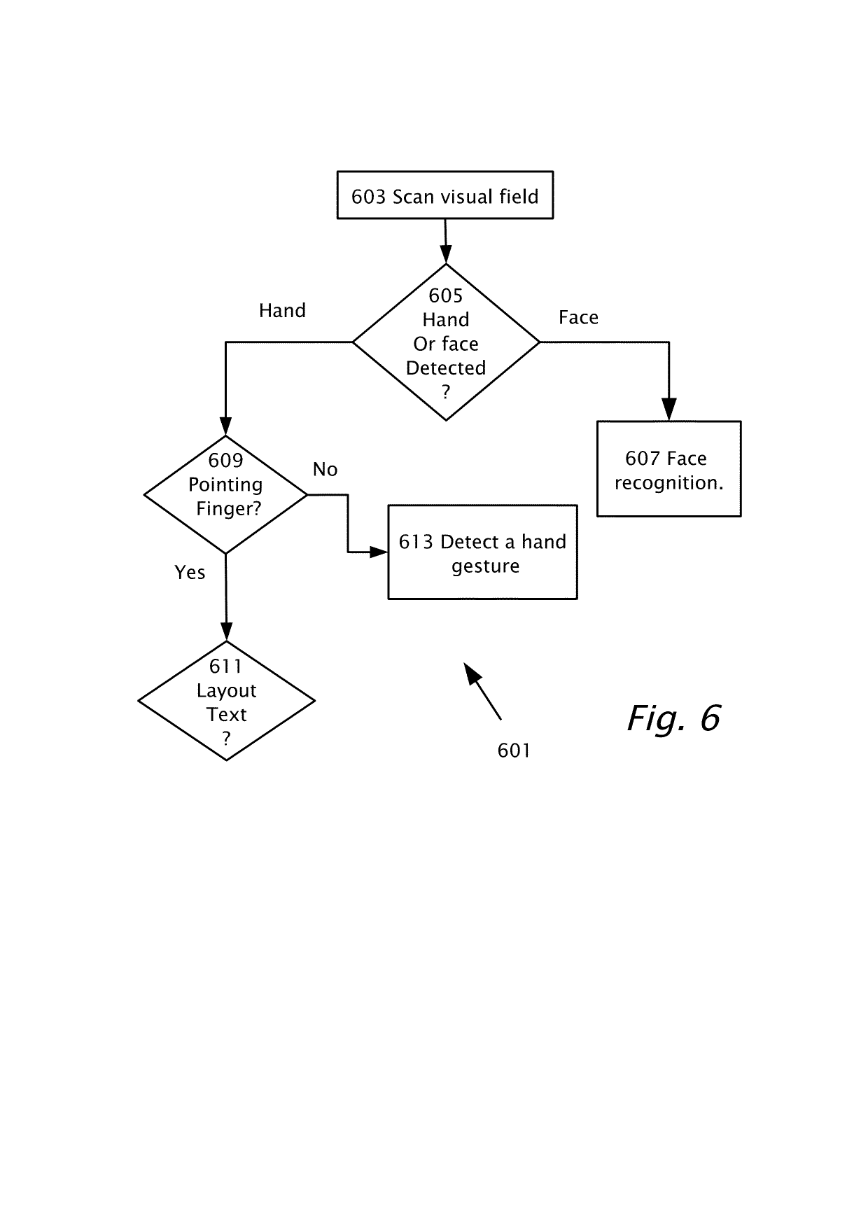

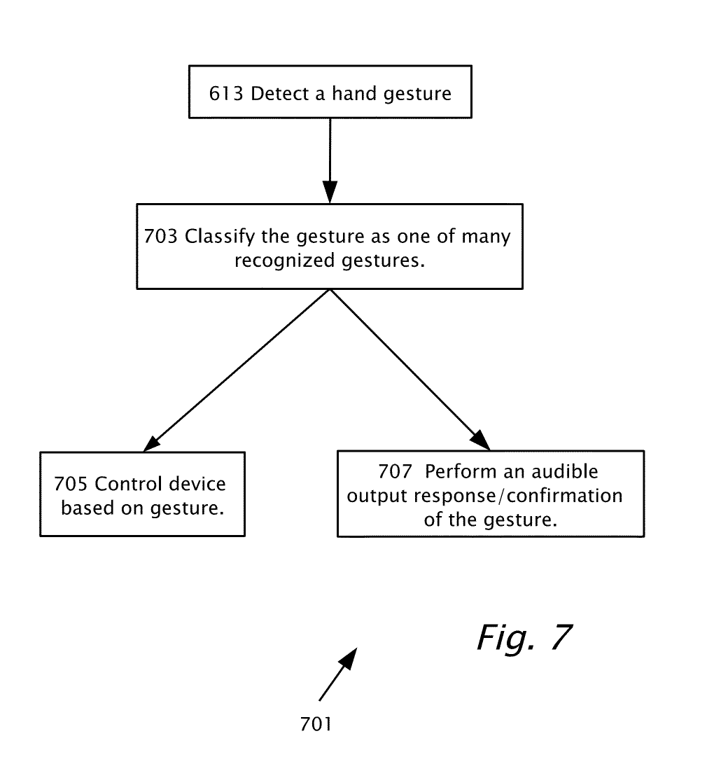

Reference is now made to FIG. 5a which shows a method 501 for training a multi-class classifier 509, according to a feature of the present invention. Training of classifier 509 is performed prior to using trained classifier 509 to classify for example gestures, bank notes, vehicles, particularly buses and/or traffic signals or traffic signs. Training images 503, for example of bank notes for a particular country, are provided and image features of the bank notes are extracted in step 505. Features extracted (step 505) from training images 503 may include optical gradients, intensity, color, texture and contrast for example. Features of the bank notes for a particular country may be stored (step 507) to produce a trained classifier 509. A similar exercise may be performed for steps 503 and 505 with respect to hand gestures. Features of hand gestures may be stored (step 507) to produce a. trained classifier 509. An example of a multi-class classifier 509 which may be produced includes the extracted features of both bank notes as one class of objects and hand gestures as another class of objects.

Optical flow or differences between image frames 14 may be further used for classification for example to detect and recognize gesture motion or to detect and recognize the color change of a traffic signal

Reference is now made to FIG. 5b, which shows a method 511, according to a feature of the present invention. In step 513, trained classifier 509 is loaded into processor 16.

Reference is now made to FIG. 5c, which shows a method 521, according to a feature of the present invention. With trained classifier 509 loaded into processor 16 (step 513), image frames 14 are captured in step 523 of various possible visual fields of the person wearing device 40. The captured image frames 14 are then used to search (step 525) for a candidate image 527 for an object found in the image frames 14. Further processing of candidate images 527 are shown in the description that follows.

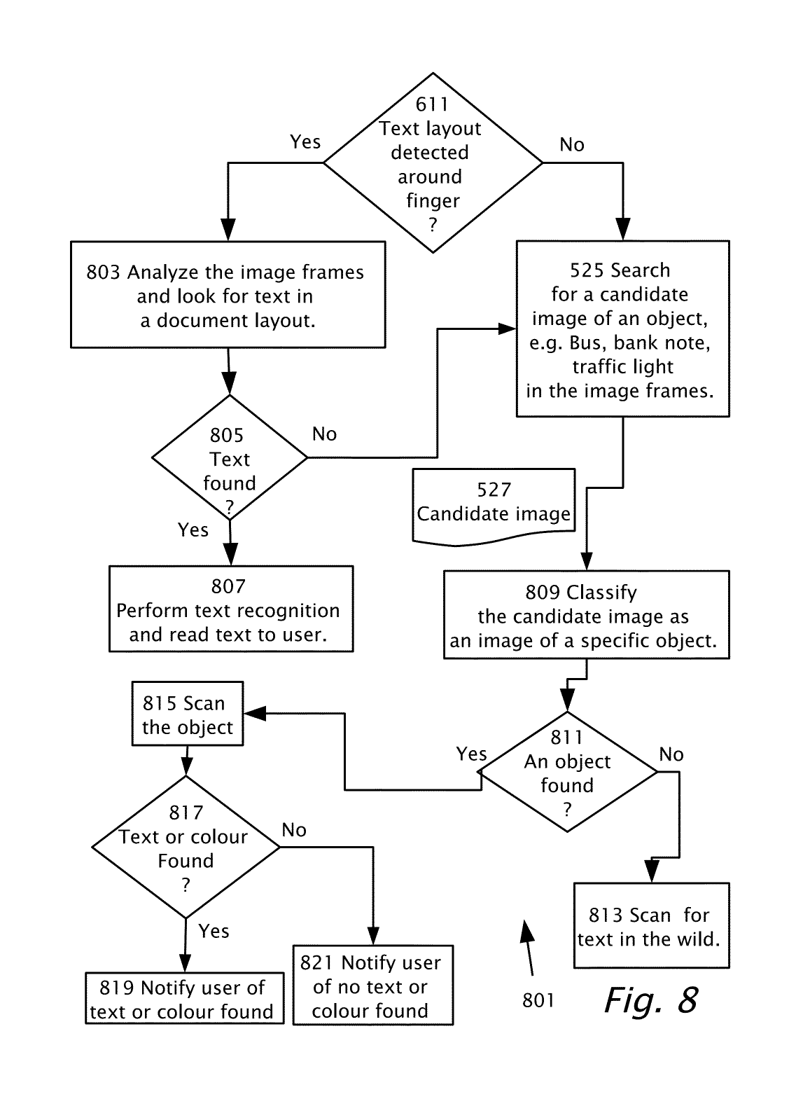

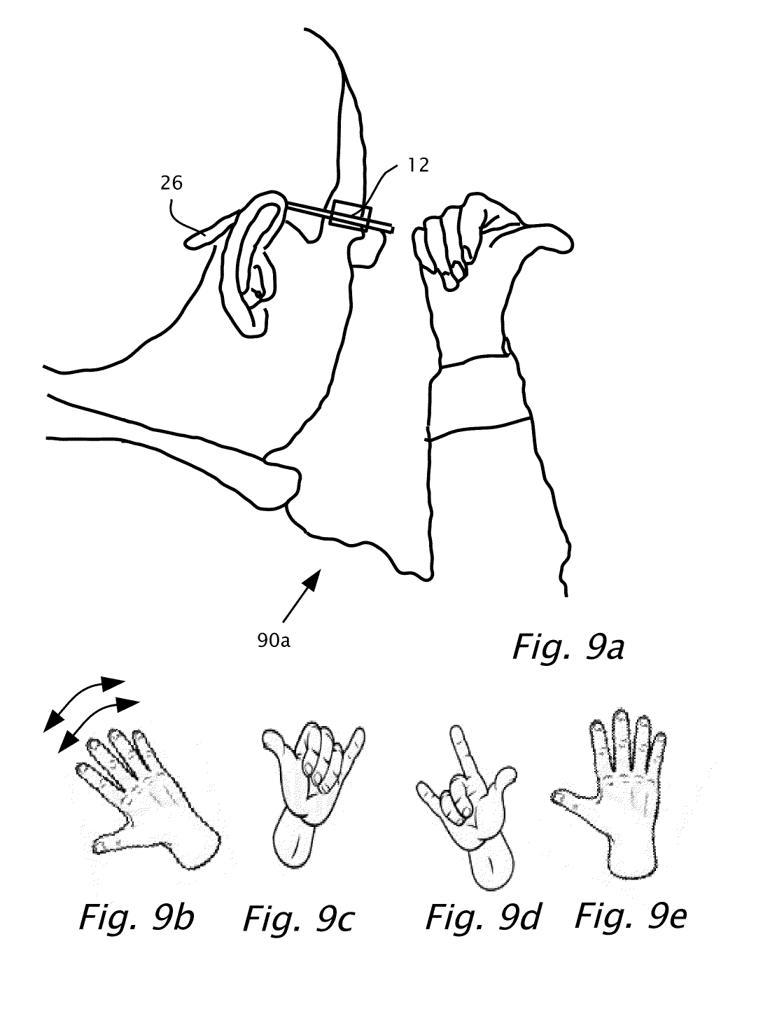

Reference is now made to FIG. 9a which shows a person wearing device 40 and visual field 90a of camera 12. The person is presenting a hand gesture in the field of view of camera 12. The gesture shown for example being the right hand palm side of the person with fingers closed and the thumb pointing out to the right. FIGS. 9b-9e show other example hand gestures which may be in visual field 90a of the person and camera 12. FIG. 9b shows the back or dorsal part of an open right hand which is being waved from side to side. FIG. 9c shows a palm side of a left hand with thumb and little finger extended. FIG. 9d shows a palm side of a right hand with thumb, little finger and index finger extended. FIG. 9e shows the back or dorsal part of an open right hand which is stationary.

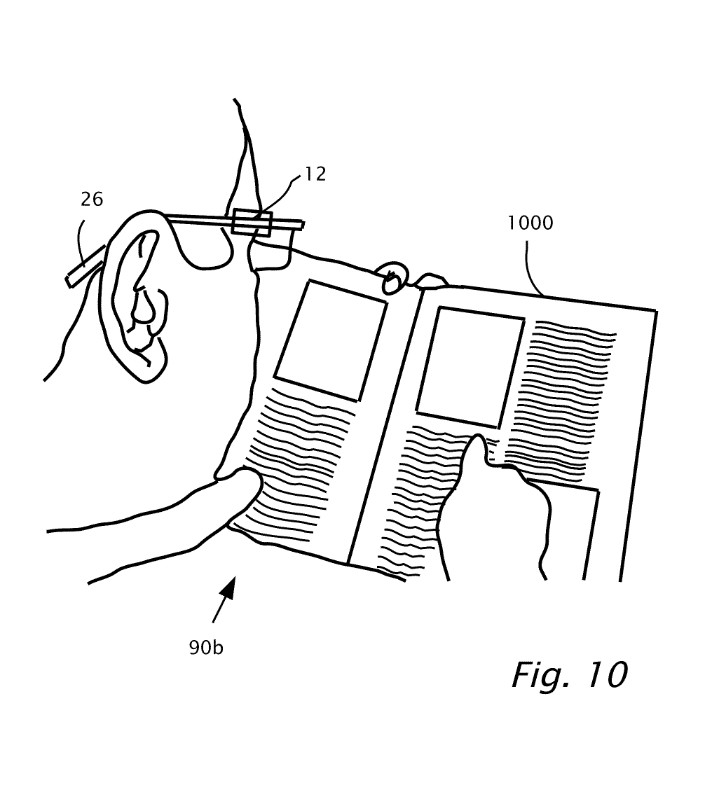

Reference is now made to FIG. 10 which shows a visual field 90b of a person wearing device 40. Visual field 90c of the person includes a document 1000 and the pointing of the index finger of the right hand to text in document 1000. Document 1000 in this case is a book but also may be a timetable, notice on a wall or a text on some signage in close proximity to the person such as text on the label of a can for example.

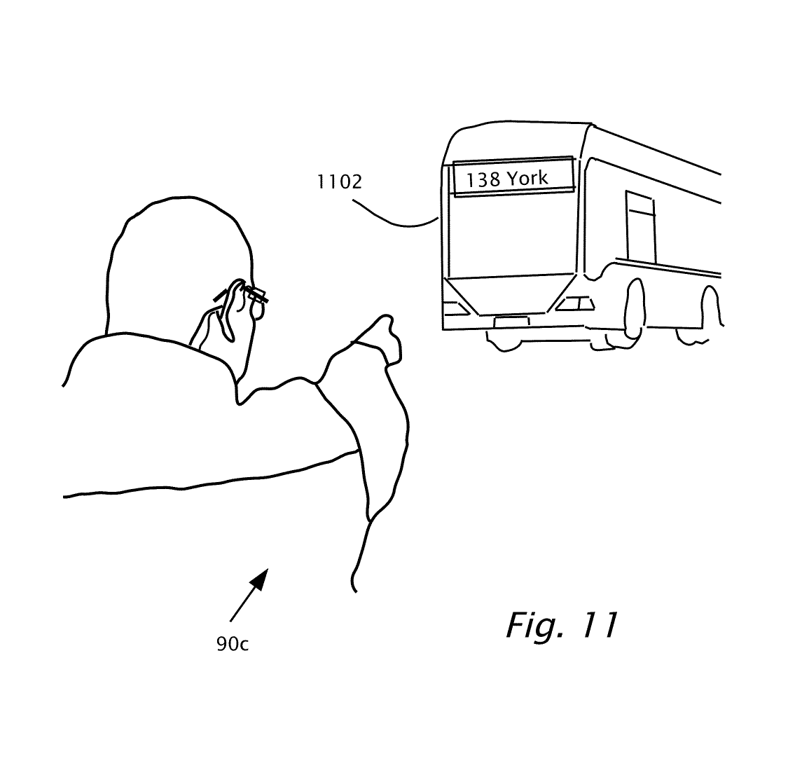

Reference is now made to FIG. 11 which shows a visual field 90c of a person wearing device 40. Here visual field 90c includes a bus 1102 and the pointing of the index finger of the right in the general direction of bus 1102. Bus 1102 also includes a text such as the bus number and destination. The text may also include details of the route of bus 1102.

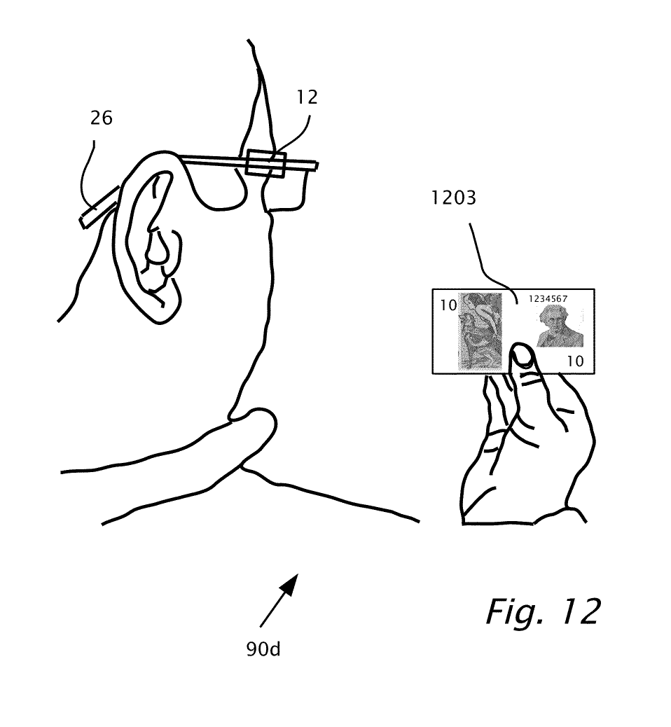

Reference is now made to FIG. 12 which shows a visual field 90d of a person wearing device 40. Visual field 90d includes the person holding a banknote 1203 or visual field 90d may have banknote 1203 on a counter top or in the hands of another person such as shop assistant for example.

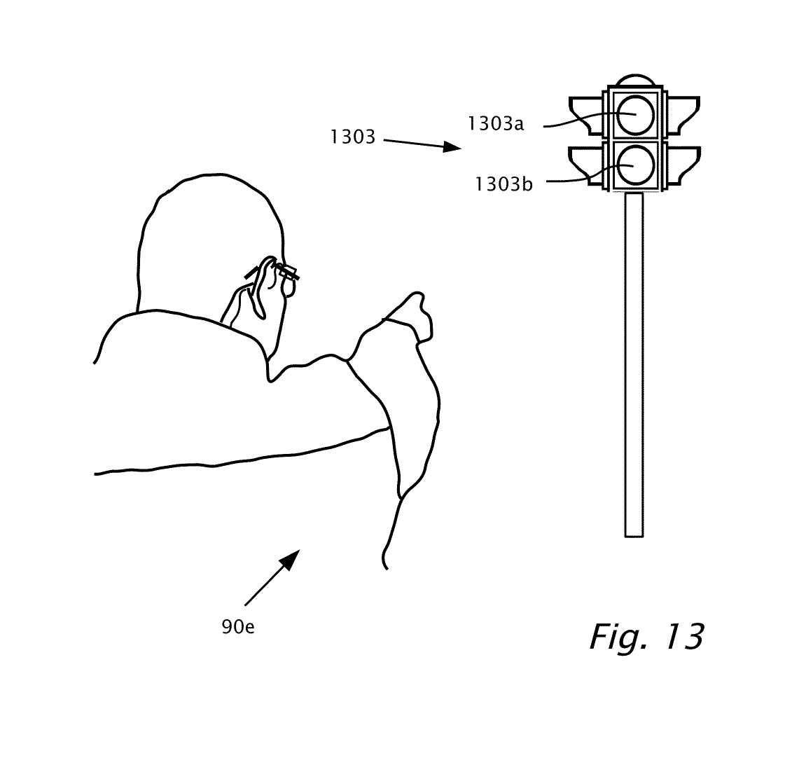

Reference is now made to FIG. 13 which shows a visual field 90e of a person wearing device 40. Here visual field 90c includes a traffic signal 1303 and the pointing of the index finger of the right in the general direction of traffic signal 1303. Here traffic signal has two sign lights 1303a (red) and 1303b (green) which may be indicative of a pedestrian crossing sign or alternatively traffic signal 1303 may have three sign lights (red, amber, green) indicative of a traffic sign used by vehicles as well as pedestrians.

Reference is now made to FIG. 6 which shows a method 601, according to a feature of the present invention. In step 603 the visual field 90 of the person and camera 12 may be scanned while device 40 is worn by the person. In decision block 605 a decision is made to determine if an object detected in visual field 90 is either a hand of the person or a face of another person. If the object detected is the face of another person, facial recognition of the other person may be performed in step 607. Facial recognition step 607 may make use of classifier 120 which has been previously trained to recognize faces of people who are known to the person. If the object detected in visual field 90 is a hand of the person, in decision box 609 it may be determined if the hand gesture is a pointing finger gesture or not. The pointing finger may be for instance a pointing index finger of the right hand or left hand of the person. If the hand does not include a pointing finger, then hand gestures may be detected starting in step 613 the flow of which continues in FIG. 7. If the finger is pointing to an attribute such as a text layout in decision box 611, the flow continues in FIG. 8.

Reference is now made to FIG. 7 which shows a method 701, according to a feature of the present invention. Method 701 is a continuation of step 613 shown in FIG. 6. In step 613 a hand gesture of a user is detected and recognized to not include a pointing finger. In step 703 the hand gesture may be classified as one of many recognizable gestures of trained classifier 509. Recognizing the hand gesture as one of many hand gestures may simultaneously provide control (step 705) of device 40 based on the hand gesture as well as providing an audible output via audio unit 26 in response to and/or in confirmation of the hand gesture (step 707). In step 705, control of device 40 may include gestures to recognize colours, to stop a process of recognizing just buses for example, increase the volume of unit 26, to stop and/or start reading recognized text, to start recording video or to take a picture. In step 707, the audible output may be click sound, bleep, a one word confirmation or to notify the person that a specific mode has been entered, such as just looking for buses and bus numbers for example. Audible output response in step 707 may alternatively or in addition include information or data related to a recognized object.

Reference is now made to FIG. 8 which shows a method 801, according to a feature of the present invention. Method 801 shows the continuation of decision step 611 shown in FIG. 6. Decision step 611 is reached by virtue of finding a finger pointing in visual field 90 in step 609. In decision step 611 it is determined if a text layout is detected around a pointing finger and if so, the resolution of camera 12 may be increased to enable analysis (step 803) of image frames 14 so as to look for example for a block of text within the text layout of a document. If text is found in decision block 805, recognition of the text is performed in step 807 and the text may be read to the person via audio unit 26. The index finger may be used to point to which specific portion of text to be recognized and to be read in the document.

In both decision boxes 805 and 611, if no text is found, a search for a candidate image 527 in the field of view 90 for an object may be performed in step 525. The search in step 525 may be made with a lower resolution of camera 12 to enable searching of the object in image frames 14. The object may be a vehicle such as a bus, a bank note and/or traffic light shown in views 90c, 90d and 90e respectively for example. The candidate image 527 may then be classified in step 809, using classifier 509 as an image of a specific object. Additionally, the person may track the candidate image to provide a tracked candidate image in the image frames 14. The tracking may be based on sound perception, partial vision or situational awareness by orienting the head-worn camera 12 in the direction of the object. The tracked candidate image may be then selected for classification and recognition.

In decision block 811, if an object is found, it may be possible to inform the person what the object is (bus 1102, bank note 1203 or traffic signal 1303 for example) and to scan the object (step 815) for attributes of the object such as text, colour or texture. If text and/or colour is found, in decision 817 on or for the object, the user may be audibly notified (step 819) via audio unit 26 and the recognized text may be read to the person. In the case of bus 1102 the bus number may be read along with the destination or route based on recognized text and/or colour of the bus. In the case of bank note 1203 the denomination of the bank note (5 British pounds or 5 American dollars) may be read to the person based on recognized text and/or colour or texture of the bank note. In the case of traffic signal 1303 based on the colour of traffic signal 1303 or a combination colour and/or text of traffic signal 1303 to stop or to walk.

If no text is found on the object then the user may be audibly notified (step 821) via audio unit 26 that no text has been found on the object. In decision step 811, if no object is found, then a scan for any text in the image frames 14 may be made in step 813. Decision step 817 may be run again after step 813 to notify of text (step 819) and unit 26 to read the text or notify (step 821) of no text found.

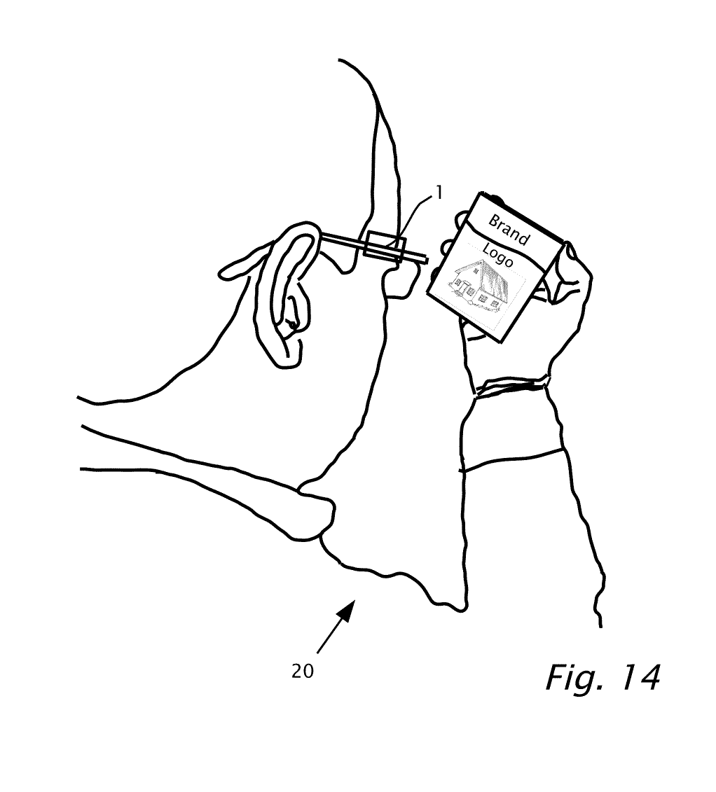

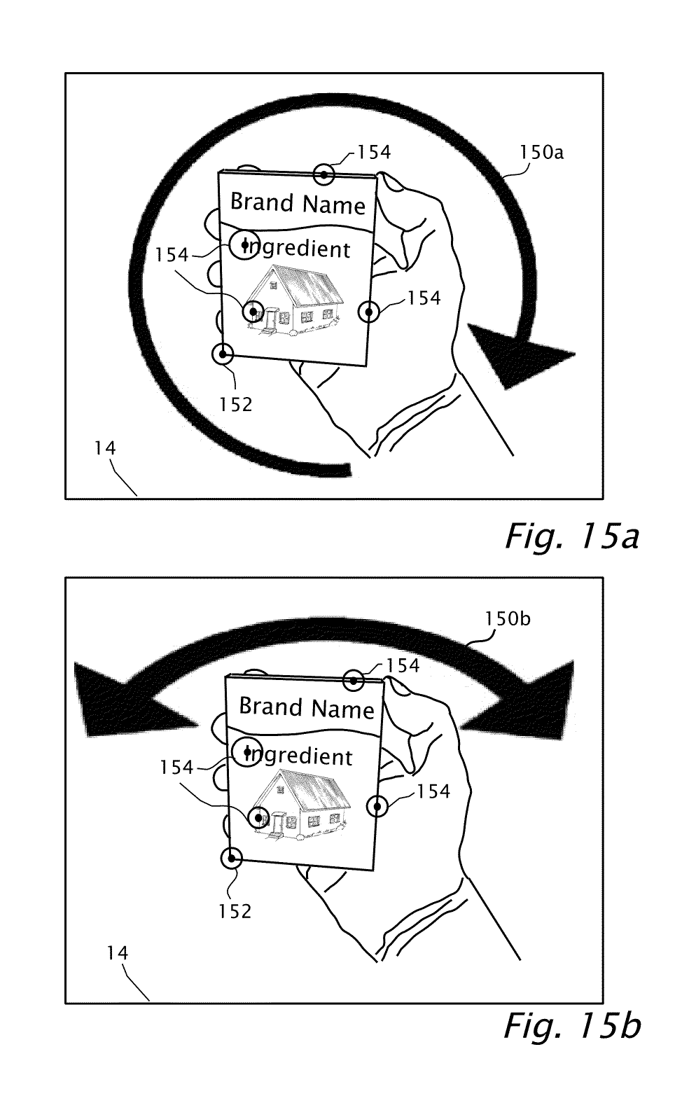

Reference is now made to FIG. 14 which illustrates a user wearing device 1 and holding an object, e.g. a package of butter, in the field of view of camera 12. A portion of an image frame 14 is shown in FIGS. 15a and 15b showing the user holding and/or moving the object. The type of movement of the object that the user may make, in successive captured image frames 14 may be repetitive: for instance, a circular movement 150a, a side to side movement 150b, and/or an up and down movement. Alternatively, there may be substantially no movement of the object. FIGS. 15a and 15b also illustrate features, e.g. corners 152 and edges or edge features 154 of the object which may be tracked by device 1 during the image motion.

According to a feature of the present invention, device 1 determines that a user is holding an object that was previously held by the user, and device 1 re-recognizes the object. Device 1 may act responsive to the re-recognition and/or use re-recognition of the object as a control input.

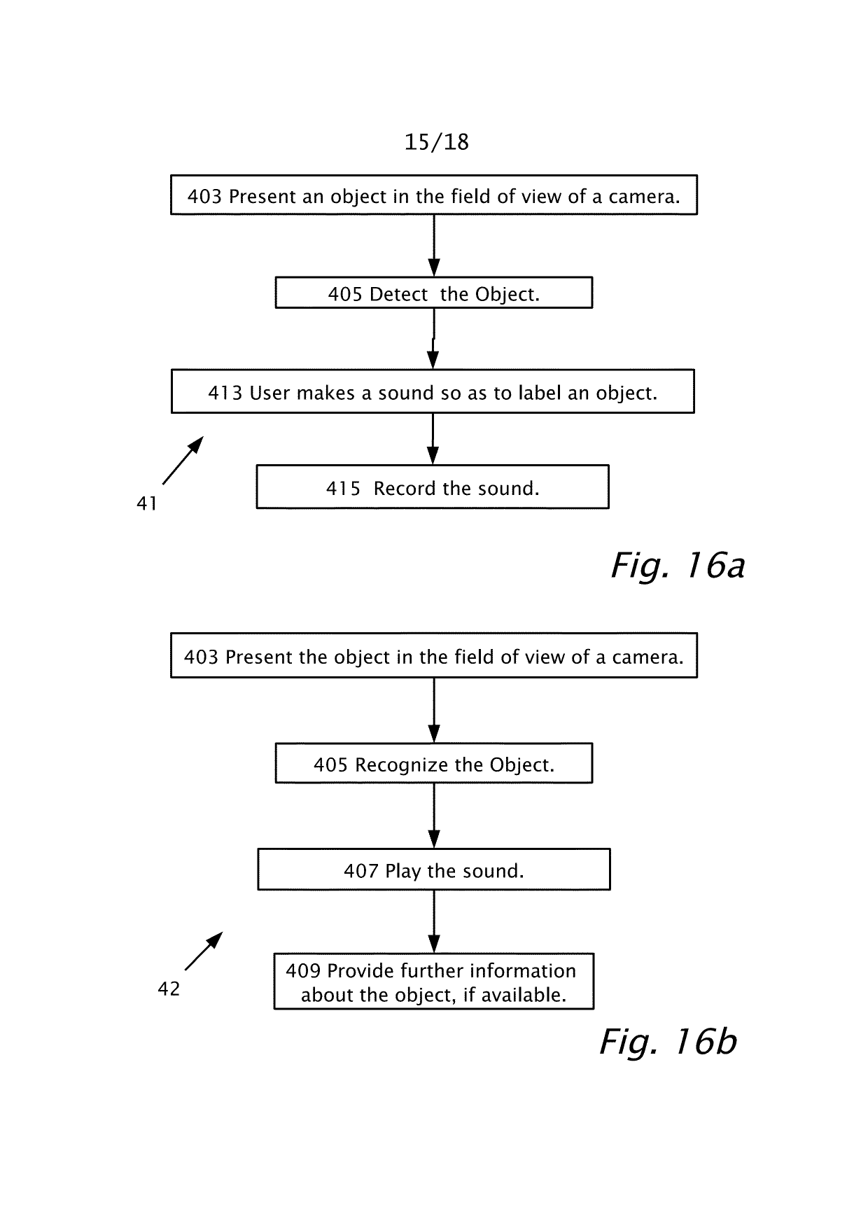

Reference is now made to FIGS. 16a and 16b which illustrate methods 41 and 42 respectively, according to aspects of the present invention.

In method 41, device 1 determines with high probability, that the user is presenting (step 403) an object in the field of view of camera 12. Device 1 may check whether the object is recognizable. Upon detecting or recognizing (step 405) the object being presented, the user may name the object or make a sound to label the object (step 413) and the sound may be recorded (step 415). A feature of the present invention is that method 41 avoids a button press. Hand motion, such as waving the object in the field of view of camera 12 or inserting the object into the field of view is sufficient to indicate to device 1 that there is an object being presented (step 403) for recognition (step 405).

Referring now to FIG. 16b, method 42 performs image-based matching in a way that is fast and flexible. The previously detected object is presented again (step 403) to camera 12 and image-based matching is performed so that the object is recognized (step 405) as the same object that was previously detected. A unique aspect to device 1 is that a user can add objects. For example, a visually impaired user may not be able to identify the particular brand of yogurt she is interested in purchasing from the store shelf. Such a user may ask for assistance once, in order to find the product. She then presents the product to device 1 and subsequently the device will tell that product apart from others, making the shopping fast and pleasant to the user. Another example is a visually impaired person who pays using cash and needs to ensure that he/she receives the correct change, as device 1 may identify the bank notes and coins.

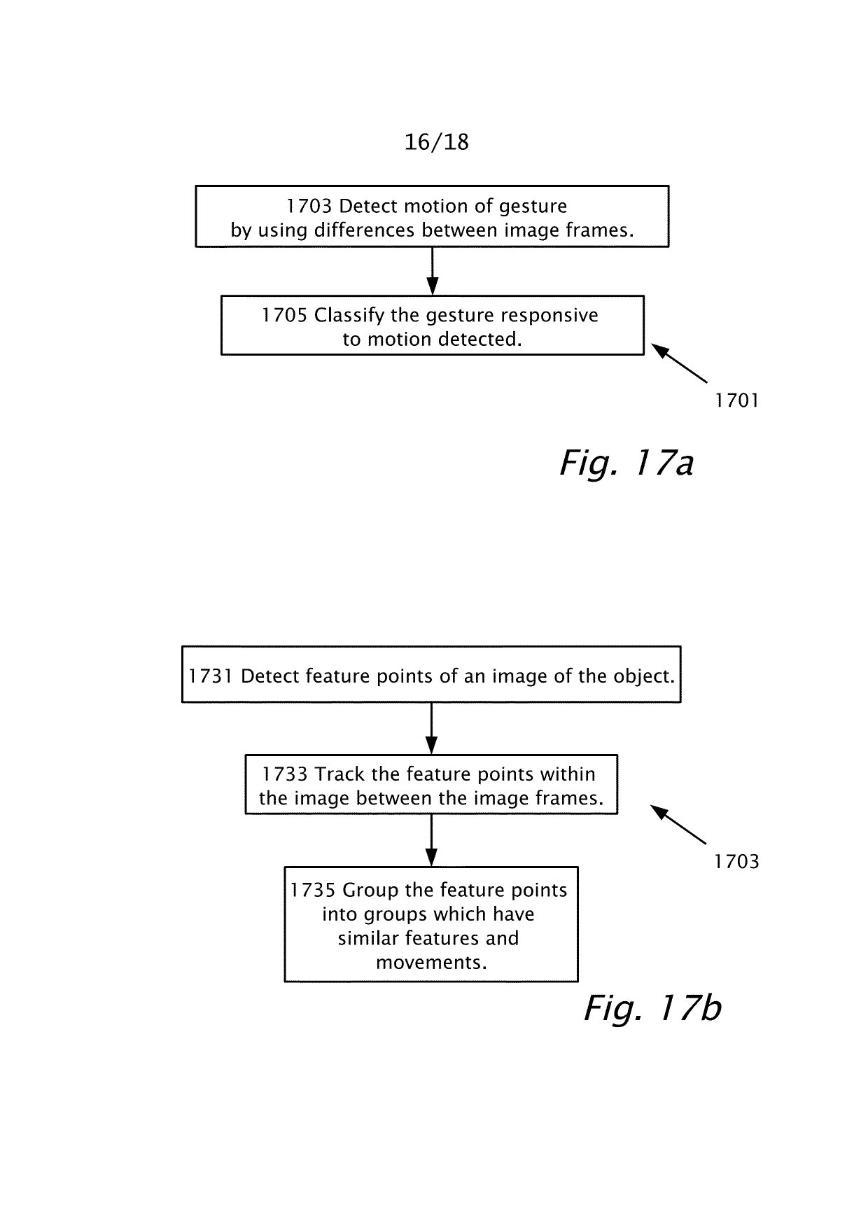

Reference is now made to FIG. 17a which shows a flow diagram of a method 1701, according to a feature of the present invention. In step 1703, motion of an object held by a user of device 1 is detected using differences between image frames 14. Based on the motion detected of the object between image frames in step 1703, the object is classified in step 1705. Alternative steps according to different aspects of the present invention may follow classification step 1705. A failure to classify the object may be audibly given to the user by audio unit 26. A successful classification in step 1705 may allow the user to name the object (step 1707) and record the name of the object. A successful re-recognition in step 1705 may allow the user to audibly hear from audio unit 26, text being read aloud by using optical character recognition (OCR) of characters on the object.

Reference is now made to FIG. 17b which shows an aspect of motion detection of a gesture (step 1703) in greater detail, according to a feature of the present invention. In step 1731, feature points of the object are detected as the object is held in the hand of the user and moved by the hand of the user. Referring again to again to FIGS. 15a, 15b, the feature points may be corners 152 and edge features 154 of the object. Corners 152 and edge features 154 may be provided by algorithms known in the art of image processing such as Scale-invariant feature transform (SIFT) or Harris corners. From the way the user holds the object in her hand, it may be understood that the object includes a gesture intended for control of device 1. Alternatively or in addition, in step 1733, the features such as corners 152 and edge features 154, which may be found on the object and/or the hand of the user holding the object, may be tracked by device 1 between image frames 14. The features may be grouped (step 1735) into groups which have similar features and movements. Repetitive motion of features 152, 154 may be used by device 1 to indicate a control input to device 1.

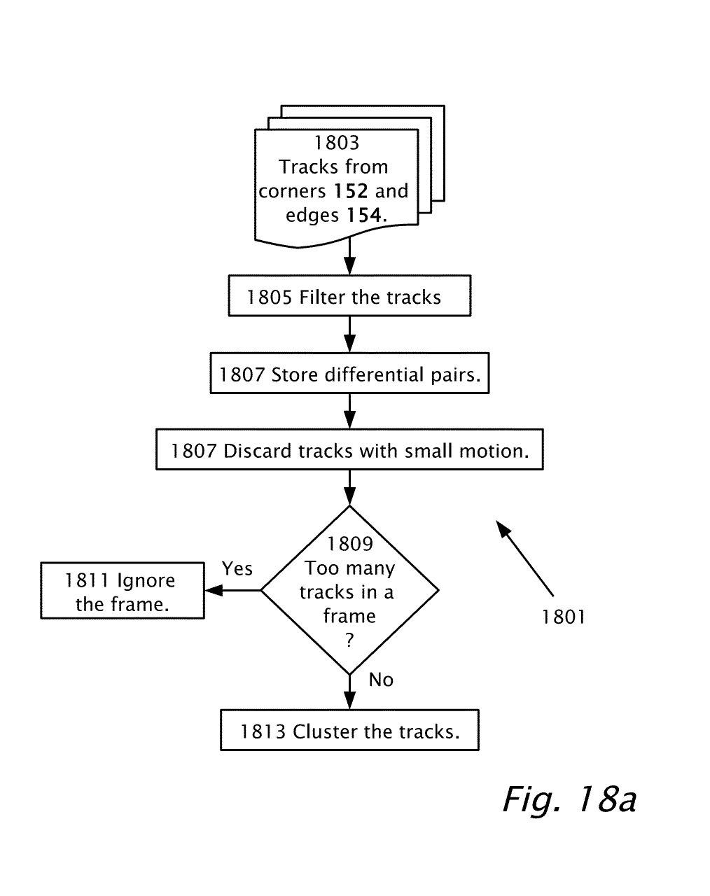

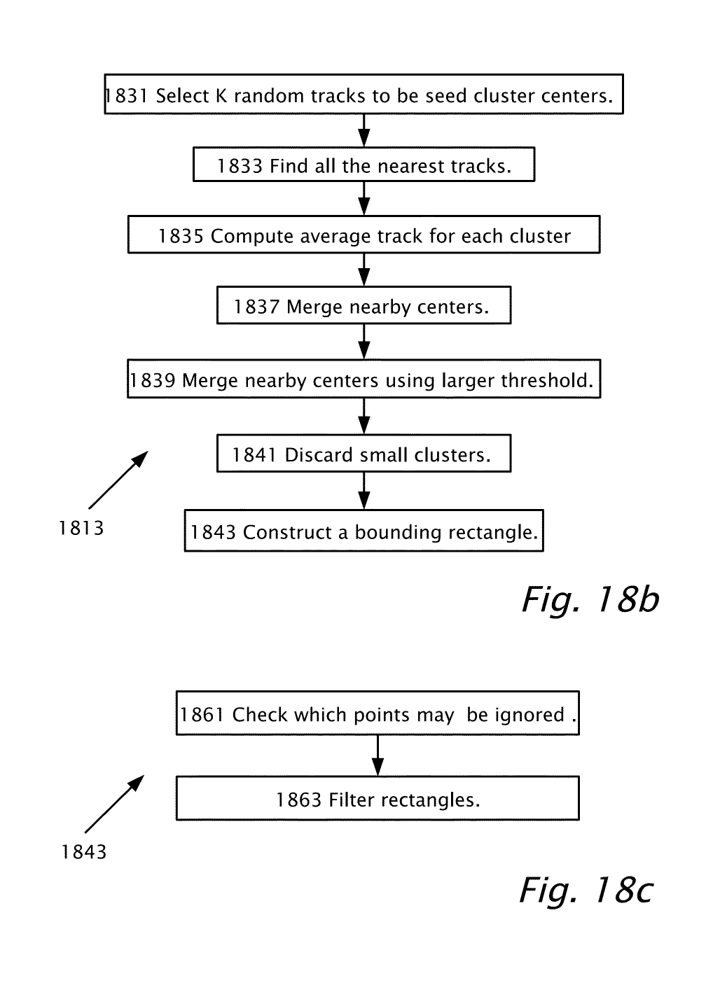

Reference is now made to FIG. 18a which illustrates a flow diagram of a method 1801, according to features of the present invention for tracking features of an object between image frames 14. Method 1801 receives an input 1803 including tracks from features e.g. corners 152 and edges 154, from a number, e.g. 11, of previous image frames 14. The tracks from the tracked features are filtered (step 1805) and for each track, differential pairs (dx, dy) pairs e.g. 10 pairs are stored (step 1807), where x and y are Cartesian axes in image space. Shorter tracks may be ignored and may be discarded (step 1807) which have image motion below a threshold. In decision block 1809, if too many tracks remain in an image frame 14, image frame 14 may be ignored (step 1811), indicating that camera 12 has probably moved during the exposure causing the background also to move. In this way, method 1801 achieves separation of the image of a moving object or gesture from the background.

In decision block 1809, if not too many tracks remain in image frame 14, the tracks are clustered (step 1813) based on linear complexity.

Reference is now made to FIG. 18b which illustrates clustering step 1813 of FIG. 18a in greater detail, according to a feature of the present invention. K random tracks selected to be used as seed cluster centers (step 1831). Tracks nearest to the seed cluster centers may be found for each seed cluster center (up to a distance, e.g. 20*0.5, for an average 0.5 pixels per image frame 14. The average track for each cluster is computed (step 1835). Nearby cluster centers are merged (step 1837). Nearby cluster centers may be merged again using a larger threshold (step 1839). Small clusters of a few points in absolute number or percentage of total are discarded (step 1841) after which a bounding rectangle is constructed (step 1843).

Reference is now made to FIG. 18c illustrating a flow diagram of step 1843 in greater detail of constructing a bounding rectangle. For each boundary direction (up, right, down, left) a check is performed for points which may be ignored (step 1861). The points to be ignored are typically those whose removal significantly changes significantly the area of the bounding rectangle. Step 1861 is repeated a number, e.g. 3, of times. The rectangles may be filtered (step 1863) by (i) discarding rectangles that are too small (width, height), (ii) based on percentage of points from the cluster is too low compared to other tracks that lie inside the rectangle. Filtering may be performed according to the total number of tracks from features from the cluster inside the rectangle divided by the area of the rectangle.

### Multi-Frame Filtering

With multiple frames, all the rectangles from the previous image frames 14 are input and the location and scales of each rectangle to the current image frame 14 frame are updated. The updating of the location and scales of each rectangle to the current image frame 14 frame may be performed done using random sample consensus (RANSAC) to estimate motion along the tracks. A candidate for each location is then selected. Selecting the candidate for each location chooses the rectangle that best covers all the other rectangles. When a new image frame 14 arrives, the candidate may change. Whether to classify this rectangle is decided on the basis of:
If the homography indicates too large an image motion, then ignore the rectangle because the image might be blurry.
rectangles are re-sent until there is one image in which the classifier gets a high score
rectangles that failed too many times, are later ignored so as to save computing power.

### Definitions

The term “edge or “edge feature” as used herein refers to an image feature having in image space a significant gradient in gray scale or color.

The term “edge direction” is the direction of the gradient in gray scale or color in image space.

The term “detection” is used herein in the context of an image of an object and refers to recognizing an image in a portion of the image frame as that of an object, for instance an object of a visually impaired person wearing the camera. The terms “detection” and “recognition” in the context of an image of an object are used herein interchangeably, although detection may refer to a first instance and recognition may refer to a second or subsequent instance.

The term “motion detection” or detection of motion as used herein refers to detection of image motion a features of an object between image frames.

The term “image intensity” as used herein refers to either gray scale intensity as in a monochromatic image and/or one or more color intensities, for instance red/green/blue/, in a color image.

The term “classify” as used herein, refers to a process performed by a machine-learning process based on characteristics of an object to identify a class or group to which the object belongs. The classification process may also include the act of deciding that the object is present.

The term ‘field of view” (FOV) as used herein is the angular extent of the observable world that is visible at any given moment either by an eye of a person and/or a camera. The focal length of the lens of the camera provides a relationship between the field of view and the working distance of the camera.

The term “attribute” as used herein, refers to specific information of the recognized object. Examples may include the state of a recognized traffic signal, or a recognized hand gesture such as a pointed object which may be used for a control feature of the device; the denomination of a recognized bank note is an attribute of the bank note; the bus number is an attribute of the recognized bus.

The term “tracking” an image as used herein, refers to tracking features of an image over multiple image frames.

The term “frame front” as used herein refers to the front part of the eyeglass frame that holds the lenses in place and bridges the top of the nose.

The term “bone conduction” as used herein refers to the conduction of sound to the inner ear through the bones of the skull.

The term “classify an object” is used herein in the context of vision processing of candidate image and refers to recognizing an object to belong to a specific class of objects. Examples of classes of objects include buses, hand gestures, bank notes and traffic signals.

The term “classify a gesture” as used herein refers to recognizing the gesture as an input to the device.

The term “attribute” is used herein refers to specific information of the recognized object. Examples may include the state of a recognized traffic signal, or a recognized hand gesture which may be used for a control feature of the device; the denomination of a recognized bank note is an attribute of the bank note; the bus number is an attribute of the recognized bus.

The objects of a hand are termed herein as follows: the first object is a thumb, the second object is also known herein as an “index object”, the second object is known herein as an “index” object, the third object is known herein as a “middle object”, the fourth object is known herein as “ring object” and the fifth object is known herein as “pinky” object.

The indefinite articles “a”, “an” is used herein, such as “a candidate image”, “an audible output” have the meaning of “one or more” that is “one or more candidate images” or “one or more audible outputs”.

Although selected features of the present invention have been shown and described, it is to be understood the present invention is not limited to the described features. Instead, it is to be appreciated that changes may be made to these features without departing from the principles and spirit of the invention, the scope of which is defined by the claims and the equivalents thereof.

1. A method for visually assisting a person using a device wearable by the person, wherein the device includes a processor operatively connectible to a camera, wherein the processor is adapted to capture a plurality of image frames, the method comprising:
detecting motion of a gesture by using differences between the image frames;
classifying said gesture responsive to said detected motion.

2. The method of claim 1, wherein said motion of said gesture is repetitive.

3. The method of claim 1, wherein said detecting and said classifying are performed while avoiding pressing of a button on the device.

4. The method of claim 2, wherein said gesture includes selectively either holding an object in a hand of the person or waving said object held in said hand in the field of view of the camera.

5. The method of claim 4, further comprising:
enabling the person to audibly name said object; and
recording said name.

6. The method of claim 4, further comprising:
audibly informing the person upon failing to classify said object.

7. The method of claim 4, further comprising:
classifying said object; wherein said classifying is performed using a trained classifier; and
upon the device failing to detect a new object, further training said classifier by the person audibly naming the new object.

8. The method of claim 4, further comprising:
performing said detecting by identifying portions of a hand holding said object.

9. The method of claim 1, wherein said detecting includes:
detecting features of an image of said object;
tracking the features within the image between said image frames;
grouping said features into groups, wherein said groups include said features with similar image movement.

10. The method of claim 1, further comprising:
performing optical character recognition (OCR) of characters on said object.

11. A device wearable by the person, wherein the device includes a processor operatively connectible to a camera, wherein the processor is adapted to capture a plurality of image frames, the device operable to:
detect motion of a gesture by using differences between the image frames;
classify said gesture responsive to said detected motion.

12. The device of claim 11, wherein said motion of said gesture is repetitive.

13. The device of claim 11, further comprising:
an earphone operatively attached to said processor, wherein the device detects an object and recognizes the object, wherein said processor audibly informs the person by utilizing said earphone to name said object.

14. A method of using a device including a camera and a processor, the method comprising:
upon presenting an object to the device for a first time, detecting the object;
upon said detecting, labeling by a person the object using a sound;
recording the sound by the device, thereby producing a recorded sound;
upon second presenting the object a second time to the device, recognizing the object and upon said recognizing, playing said recorded sound by the device for hearing by a person.

15. The method according to claim 14, the method further comprising:
upon said presenting the object said second time to the device,
providing by the device further information associated with the object.

16. The method according to claim 14, wherein said presenting includes moving the object in the field of view of the camera, and wherein said moving triggers the device to act in response.

17. The method according to claim 14, further comprising:
prior to said detecting, tracking motion of the object; and
separating the image of the object from image background responsive to the tracked motion of the object.

18. The method according to claim 14, wherein said presenting includes inserting the object into the field of view of the camera and wherein said inserting triggers the device.

19. The method according to claim 14, wherein the object is not successfully recognized, the method further comprising:
playing an audible sound to the person indicating that the object is not recognized.

20. The method according to claim 14, further comprising:
managing a data base of objects personal to the person, wherein said objects when presented to the device are recognizable by the device.
